(19) United States
(12) Patent Application Publication
(10) Pub. No.: US 2025/0087079 A1
(43) Pub. Date: Mar. 13, 2025

(54) TRUCK TRAILER DOCK WATCHING DEVICE AND METHOD

(71) Applicants: ROGER B HERZOG, COVINGTON, IN (US); CHAD A. HERZOG, COVINGTON, IN (US)

(72) Inventors: ROGER B HERZOG, COVINGTON, IN (US); CHAD A. HERZOG, COVINGTON, IN (US)

(21) Appl. No.: 18/803,356

(22) Filed: Aug. 13, 2024

Related U.S. Application Data
(60) Provisional application No. 63/532,402, filed on Aug. 13, 2023.

(51) Int. Cl. G08C 17/02; G08B 3/00; G08B 5/00

(52) U.S. Cl. CPC G08C 17/02; G08B 3/00; G08B 5/00; G08C 2201/30

(57) ABSTRACT

A device for assisting truckers monitoring a docking station to watch and alert an operator/user when workers indicate that loading or unloading has finished. The device includes a sensor for: (a) detecting when the green light for the loading dock has been illuminated indicating that loading or unloading is finished and the rig can be safely removed from its temporary docking point; and (b) emitting a signal to (iii) a user receiving device indicating that the loading dock green light has illuminated.

### CROSS-REFERENCE TO RELATED APPLICATIONS

This application is a perfection of U.S. Provisional Application Ser. No. 63/532,402, filed on Aug. 13, 2023, the disclosure of which is fully incorporated by reference herein.

### STATEMENT REGARDING FEDERALLY SPONSORED RESEARCH OR DEVELOPMENT

Not Applicable.

### THE NAMES OF THE PARTIES TO A JOINT RESEARCH AGREEMENT Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable.

### BACKGROUND OF THE INVENTION

### (1) Field of the Invention

This invention relates to loading docks. More particularly, it relates to monitoring or alerting systems for trucks and trailers at a loading dock.

When a truck, trailer or some other vehicle is parked at the loading dock of a building, a manually operated vehicle brace is often used to prevent the vehicle from moving unexpectedly as cargo is transferred into or out of the vehicle. Some example vehicle braces include wheel chocks, manually operated vehicle restraints, and portable trailer stands. A wheel chock wedges between a dock driveway and the wheel of a vehicle to prevent it from accidentally pulling away from the dock.

Manually operated vehicle restraints include wheel-blocking barriers mounted to a track. The track is positioned on the driveway generally parallel to the parking area. The barrier can be manually moved along the track to position the barrier just ahead of a wheel of the vehicle. The barrier can then be manually moved laterally directly in front of the wheel, thereby blocking the wheel and preventing the vehicle from accidentally moving forward.

When the vehicle is a tractor/trailer combination, a locking device operated from inside the dock is used to secure the vehicle to the dock and prevent it from moving during the loading/unloading process.

### (2) Description of Related Art Including Information Disclosed Under 37 CFR 1.97 and 1.98

This invention represents an improvement over U.S. Pat. No. 10,676,295, the disclosure of which is fully incorporated by reference herein. In that reference, a dock alarm system is combined with the foregoing vehicle restraint, wheel blocks/chucks.

As compared to that prior art patented system, this invention: (a) senses only green light; (b) communicates via an app to notify the driver; (c) through that app, records dock times and locations; (d) is rechargeable; (e) uses Bluetooth; (f) notifies the user if its main device component has been left at the dock station; and (g) notifies the user if its main device has fallen off the loading dock light.

### BRIEF SUMMARY OF THE INVENTION

This is a dock watching device (and method of use) for a truck/trailer operator—user to affix to a standard dock warning light system. Once quickly installed over the dock warning light, the operator—user will be electronically notified through the phone app when loading/unloading is complete and the rig (truck/trailer) is safe to leave the docking station. The device consists of: (i) a telescopic arm and clip for hanging onto the red-green light display of a standard loading dock in such a manner as to detect when the green light of that display has been illuminated; (ii) a sensor for: (a) detecting when the green light for the loading dock has been illuminated indicating that loading or unloading is finished and the rig can be safely removed from its temporary docking point; and for (b) emitting a signal to (iii) a user receiving device indicating that the loading dock green light has illuminated, and (iv) a charging connector for the user receiving device for keeping the receiving device sufficiently powered to wirelessly receive a signal from the sensor when the green light illumination has been detected. Preferably, the user receiving device is a portable cell phone, Apple or Android, onto which a specific phone app has been installed. That phone app includes the underlying software for receiving the emitted signal detected by the sensor and transferring to an alarm.

A method for using the device is also disclosed.

A preferred branding of this device and method is the DOCK WATCH™ system.

### BRIEF DESCRIPTION OF THE SEVERAL VIEWS OF THE DRAWING(S)

Further features, objectives and advantages of the present invention will become clearer when reviewed relative to the accompanying FIGURES in which:

FIG. 1 is a front view of the prior art dock system from FIG. 1A of U.S. Pat. No. 10,676,295 (the '295 patent) and the vehicle braces 24a and b used therein. The elemental numbers used in this FIG. 1 are described in detail in the '295 Patent. It shows two full side-by-side docking bays each with their own warning signal consisting of a columnar red light over a green light operated by the dock system operators as to when loading IN or unloading FROM has finished. It should be noted that the present invention represents a significant improvement over the '295 Patent system.

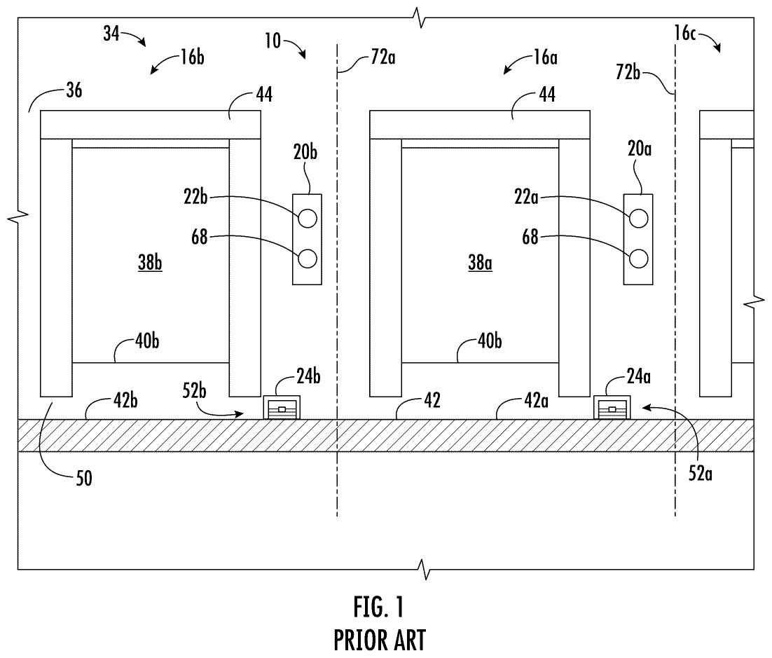

FIG. 2 is a representative red light-green light display RG on a sidewall S of a typical docking bay DB. Note, the warning caution C beneath the RG display.

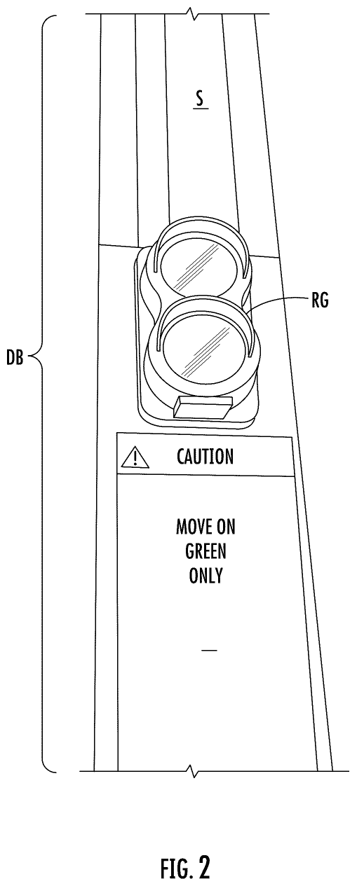

FIG. 3 is a top view of one example of this invention, generally 10, consisting of: (i) the Dock Watch™ telescopic handle TH and clip end CE for hanging onto the red light-green light warning display (not shown) of a dock proper in such a manner so as to receive, and then transmit to the user's phone (on his/her person, OR inside the truck cab), when the green light of that warning display (item RG in FIG. 4) illuminates; and (ii) the power cord/communication cable PC for receiving the GREEN—go signal from the telescopic handle and transmitting same to the user's phone app (Apple OR Android), not shown.

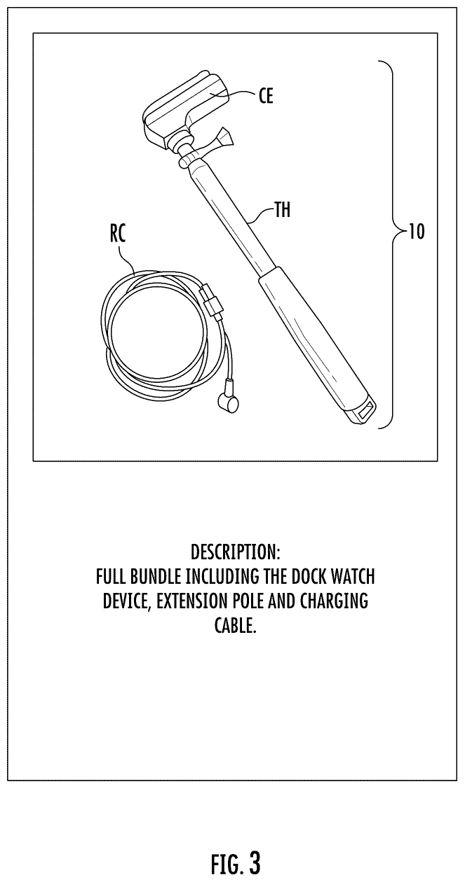

FIG. 4 is a front view of the telescopic handle TH from FIG. 3 as it was hung/installed via clip end CE over a docking station's red-green warning light display RG.

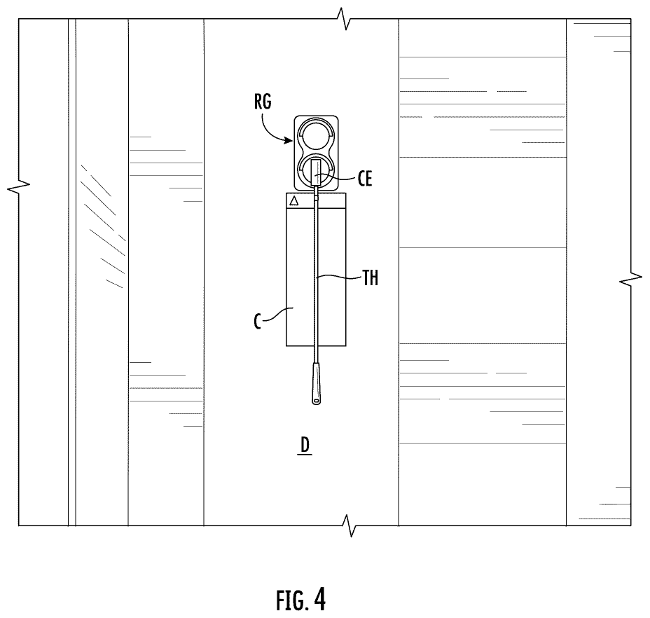

### DETAILED DESCRIPTION OF THE INVENTION

Example monitoring and alerting systems for enhancing safety associated with a loading dock system that supports cargo loading and/or unloading from the vehicle (truck or trailer). The DOCK WATCH™ system attaches above ground level directly to the dock's red-green light warning system for allowing the operator/user to sit/rest in his/her cab until alerted that loading or unloading has finished—rather than sitting inside the cab and waiting/watching for the green light to illuminate. The DOCK WATCH system allows the operator/user to rest more comfortably; no more watching the light or sleeping with one eye open and not getting quality rest. This invention will watch for the green light for the purchaser of this system.

Additional features include alerting the operator/user if—when the system accidentally disconnects, or when the operator starts to leave his/her docking station BEFORE retrieving the handle component—for reuse at the next docking stop or if the device happens to fall off the light.

With background software in the system, the device component of this invention will make life easier for truckers by aggregating and, in live time, keeping pivotal information/data including: average unloading times for a given drop stop so that other drivers in the system will know.

Having described the best modes currently known for practicing this system and method, it is to be understood that the scope of this invention may be further described by the attached claims.

### SEQUENCE LISTING

Not applicable.

1. A device for assisting truckers monitoring a docking station to watch and alert an operator/user when workers indicate that loading or unloading has finished, said device adapted for temporary installation, above ground, adjacent a green light indicator for the docking station in which the operater/user has temporarily parked for loading or unloading, said device including:
i. a telescopic arm and clip end for hanging onto the green light indicator of the docking station to detect when the green light of the indicator has been illuminated;
ii. a sensor for: (a) detecting when the green light for the docking station has been illuminated indicating that loading or unloading is finished and the rig can be safely removed; and for (b) emitting a signal;
iii. a user receiving device indicating that the green light of the docking station has been illuminated, and
iv. a charging connector for the user receiving device for keeping the user receiving device sufficiently powered.

2. The device of claim 1, which includes a warning signal should the operator/user leave before retrieving/removing the device from the docking station.

3. The device of claim 1, which includes a signal should the sensor separate from the green light of the docketing system prematurely.

4. The device of claim 1 wherein the user receiving device is a cell phone having a signal receiving app installed thereon.

5. The device of claim 1 wherein the user receiving device is a dashboard display.

6. The device of claim 1, which includes an audible alert.

7. The device of claim 1, which includes a visual alert.

8. A device for remotely monitoring a truck docking station to watch and alert an operator/user when workers indicate that notify an operator when loading or unloading has finished and a green light indicator has illuminated, said device including:
(i) a telescopic arm and clip end for hanging on the green light indicator of the docking station to detect when the green light of the indicator has been illuminated;
(ii) a sensor for: (a) detecting when the green light for the docking station has been illuminated and (b) sending a signal indicating loading or unloading has finished; and
(iii) a cell phone having an app for receiving the signal from the sensor and alerting the operator/user accordingly.

9. The device of claim 8 which further includes
(iv) a charging connector.

10. The device of claim 8, which includes a warning signal should the operator/user leave before retrieving/removing the device from the docking station.

11. The device of claim 8, which includes a signal should the sensor separate from the green light prematurely.

12. The device of claim 8, which includes an audible alert.

13. The device of claim 8, which includes a visual alert.

14. A method for remotely monitoring a truck docking station to watch and alert an operator/user when workers indicate that notify an operator when loading or unloading has finished and a green light indicator has illuminated, said method comprising:
(i) providing a device that includes:
(a) a telescopic arm and clip end for hanging on the green light indicator of the docking station to detect when the green light of the indicator has been illuminated;
(b) a sensor for: (1) detecting when the green light for the docking station has been illuminated and (2) sending a signal indicating loading or unloading has finished; and
(c) a cell phone having an app for receiving the signal from the sensor and alerting the operator/user accordingly,
(ii) positioning the sensor adjacent the green light for the docking station;
(iii) activating the cell phone app to receive an indication form the sensor when the green light from the docking station has illuminated and
(iv) retrieving the sensor from the green light before departing the docking station.
